(19) United States
(12) Patent Application Publication
(10) Pub. No.: US 2026/0093193 A1
(43) Pub. Date: Apr. 2, 2026

(54) IMAGE-FORMING APPARATUS THAT GENERATES DEVELOPING VOLTAGE

(71) Applicant: CANON KABUSHIKI KAISHA, Tokyo (JP)

(72) Inventor: JUNICHI HIROTA, Ibaraki (JP)

(21) Appl. No.: 19/338,982

(22) Filed: Sep. 24, 2025

(30) Foreign Application Priority Data
Sep. 30, 2024 (JP) 2024-171511
Jul. 9, 2025 (JP) 2025-116028

(51) Int. Cl. G03G 15/06; G03G 15/00; H02M 7/5387

(52) U.S. Cl. CPC G03G 15/065; G03G 15/5004; G03G 15/55; G03G 15/80; H02M 7/53871

(57) ABSTRACT

Provided is an image-forming apparatus that includes a developing device that develops an electrostatic latent image with a developing voltage generated by a generation circuit. The generation circuit includes a transformer, an H-bridge circuit composed of first, second, third and fourth switches connected to a first side of the transformer, a power source connected to the first and third switches, a driving circuit that outputs a first driving signal controlling the first and fourth switches, and a second driving signal controlling the second and third switches. In a second side of the transformer, an alternating current voltage component is generated that has an amplitude corresponding to a duty ratio between a period in which a positive voltage is applied to the first side, and a period in which a negative voltage is applied to the first side in accordance with the first and second driving signals.

### BACKGROUND

### Field of the Technology

The present disclosure relates to an image-forming apparatus that generates a developing voltage.

### Description of the Related Art

Conventionally, an image-forming apparatus of an electrophotographic method is known that forms an electrostatic latent image on a surface of an image bearing member, and develops the electrostatic latent image by supplying toner from a developing device to the image bearing member. In such an image-forming apparatus, if an alternating current voltage component is superimposed on a developing voltage applied to the developing device, transfer of toner from the developing device to the image bearing member will become smooth, and the developing performance will be enhanced. In general, a square wave is used as a waveform of an alternating current voltage component.

In electrophotographic printing, image quality deterioration can occur, such as a ring mark that occurs in a toner image due to an electric discharge between a developing device and an image bearing member, and a white void that occurs as a result of toner that is supposed to adhere to a low-density area being guided to a high-density area. U.S. Pat. No. 8,326,171 discusses technology to cause positive and negative voltage amplitudes of an alternating current voltage component of a developing voltage to be different in order to prevent such image quality deterioration. In an image-forming apparatus discussed in U.S. Pat. No. 8,326,171, an alternating current voltage component is generated in a secondary winding of a transformer using an H-bridge circuit by applying positive and negative voltages alternatingly to a primary winding, and this alternating current voltage component is superimposed on a developing voltage output to a developing device. Voltage adjustment circuits are connected to two switches at the high side of the H-bridge circuit, and a difference between voltages that have been adjusted by these voltage adjustment circuits causes a difference between positive and negative voltage amplitudes of the alternating current voltage component.

However, a circuit configuration discussed in U.S. Pat. No. 8,326,171 leaves room for improvements in terms of the number of parts and the area of a substrate. For example, if a desired waveform can be given to the alternating current voltage component without providing the voltage adjustment circuits, the cost will be lowered by a reduction in the number of parts, and downsizing of the substrate will be promoted.

### SUMMARY

In view of the aforementioned, the present disclosure provides an improved configuration of a circuit for generating an alternating current voltage component of a developing voltage.

An aspect of the present disclosure provides an image-forming apparatus that includes a developing device configured to develop an electrostatic latent image, a voltage generation circuit configured to generate a developing voltage to be applied to the developing device, a control circuit, a detection circuit, and a control signal generation circuit. The voltage generation circuit includes a transformer; an H-bridge circuit composed of a first switch and a second switch that are connected to a first terminal of a primary-side circuit of the transformer, and a third switch and a fourth switch that are connected to a second terminal of the primary-side circuit of the transformer; a power source connected to the first switch and the third switch of the H-bridge circuit; a driving circuit configured to output a first driving signal that controls ON and OFF of the first switch and the fourth switch, and a second driving signal that controls ON and OFF of the second switch and the third switch; and a direct current (DC) output circuit configured to output a DC voltage. The control circuit is configured to output a target voltage signal indicating a target waveform. The detection circuit is configured to detect an alternating current (AC) voltage of the developing voltage output from the voltage generation circuit to the developing device, and output a detected voltage signal indicating a waveform of the detected AC voltage. The control signal generation circuit is configured to generate a first control signal and a second control signal based on comparison between the target voltage signal from the control circuit and the detected voltage signal from the detection circuit, and output the generated first control signal and second control signal to the driving circuit, the first control signal providing an instruction for turning ON or OFF the first switch and the fourth switch, and the second control signal providing an instruction for turning ON or OFF the second switch and the third switch. In a state where the first switch and the fourth switch are turned ON in accordance with the first driving signal output based on the first control signal, a positive voltage is applied to the primary-side circuit. In a state where the second switch and the third switch are turned ON in accordance with the second driving signal output based on the second control signal, a negative voltage is applied to the primary-side circuit. An AC voltage having an amplitude corresponding to a duty ratio between a period in which the positive voltage is applied and a period in which the negative voltage is applied is generated in a secondary-side circuit of the transformer. The voltage generation circuit is configured to output, to the developing device, the developing voltage obtained by superimposing the AC voltage generated in the secondary-side circuit of the transformer on the DC voltage output from the DC output circuit.

Features of the present disclosure will become apparent from the following description of embodiments with reference to the attached drawings. The following description of embodiments are described by way of example.

### BRIEF DESCRIPTION OF THE DRAWINGS

FIG. 1 is a circuit diagram showing an example of a conventional circuit configuration for generating a developing voltage.

FIG. 2 is a schematic diagram showing an example of a general configuration of an image-forming apparatus according to an embodiment.

FIG. 3 is a circuit diagram showing an example of a configuration of a voltage generation circuit according to a first embodiment.

FIG. 4 is a time chart showing examples of transitions of signal levels of several signals according to the first embodiment.

FIG. 5 is a circuit diagram showing an example of a configuration of a voltage generation circuit according to a second embodiment.

FIG. 6 is a time chart showing examples of transitions of signal levels of several signals according to the second embodiment.

FIG. 7 is a circuit diagram showing an example of a configuration of a voltage generation circuit according to a third embodiment.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made that requires all such features, and multiple such features may be combined as appropriate. Furthermore, in the attached drawings, the same reference numerals are given to the same or similar configurations, and redundant description thereof is incorporated by reference for conciseness.

### 1. Exemplary Circuit Configuration According to Related Technology

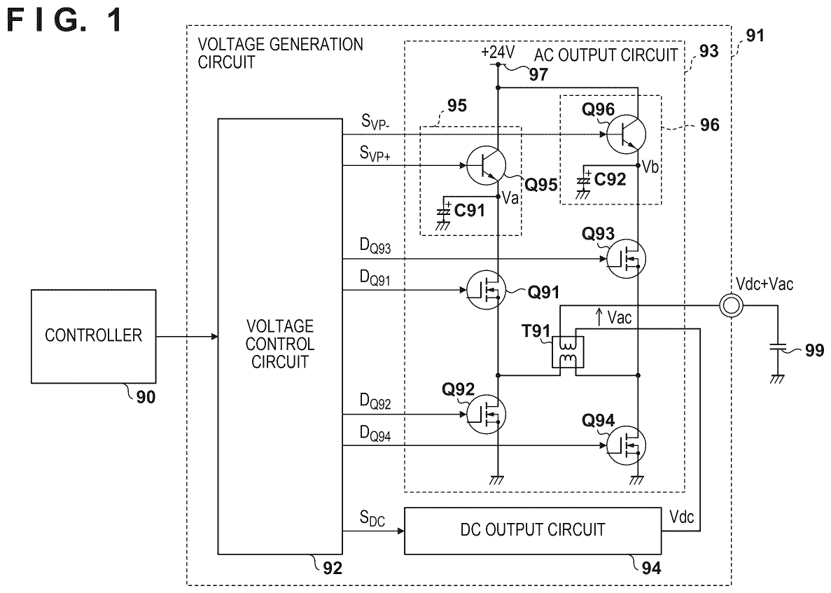

FIG. 1 is a circuit diagram showing an example of a conventional circuit configuration for generating a developing voltage related to the technology modified according to the present disclosure as described herein. Under control of a controller 90, a voltage generation circuit 91 of FIG. 1 generates a developing voltage to be output to a developing device 99. The voltage generation circuit 91 includes a voltage control circuit 92, an alternating current (AC) output circuit 93, and a direct current (DC) output circuit 94. The AC output circuit 93 includes a transformer T91, an H-bridge circuit composed of four switches Q91, Q92, Q93, and Q94, a first voltage adjustment circuit 95, a second voltage adjustment circuit 96, and a power source 97. The four switches Q91, Q92, Q93, and Q94 of the H-bridge circuit may be, for example, an n-channel field-effect transistor (FET).

The first switch Q91 and the second switch Q92 of the H-bridge circuit are connected to a first terminal of a primary-side circuit of the transformer. More specifically, a source of the first switch Q91 is connected to the first terminal of the primary-side circuit of the transformer, a drain thereof is connected to an output terminal of the first voltage adjustment circuit 95, and a gate thereof is connected to the voltage control circuit 92. The first switch Q91 is switched to an electrically conductive state (ON) when a first driving signal DQ₉₁ input from the voltage control circuit 92 becomes a high level, greater than a threshold voltage. A source of the second switch Q92 is grounded, a drain thereof is connected to the first terminal of the primary-side circuit of the transformer, and a gate thereof is connected to the voltage control circuit 92. The second switch Q92 is switched to an electrically conductive state when a second driving signal DQ₉₂ input from the voltage control circuit 92 becomes a high level.

The third switch Q93 and the fourth switch Q94 of the H-bridge circuit are connected to a second terminal of the primary-side circuit of the transformer. More specifically, a source of the third switch Q93 is connected to the second terminal of the primary-side circuit of the transformer, a drain thereof is connected to an output terminal of the second voltage adjustment circuit 96, and a gate thereof is connected to the voltage control circuit 92. The third switch Q93 is switched to an electrically conductive state when a third driving signal DQ₉₃ input from the voltage control circuit 92 becomes a high level. A source of the fourth switch Q94 is grounded, a drain thereof is connected to the second terminal of the primary-side circuit of the transformer, and a gate thereof is connected to the voltage control circuit 92. The fourth switch Q94 is switched to an electrically conductive state when a fourth driving signal DQ₉₄ input from the voltage control circuit 92 becomes a high level.

The first voltage adjustment circuit 95 is an emitter follower circuit that includes a transistor Q95 and a capacitor C91. A collector of the transistor Q95 is connected to the power source 97, a base thereof is connected to the voltage control circuit 92, and a emitter thereof is connected to the output terminal of the first voltage adjustment circuit 95. A voltage of the power source 97 is, for example, +24 V. The transistor Q95 outputs a power source voltage Va, which is dependent on a voltage of a first voltage setting signal S_{VP+} input to the base, from the emitter. That is, the first voltage adjustment circuit 95 generates the power source voltage Va corresponding to the value of the first voltage setting signal S_{VP+}.

The second voltage adjustment circuit 96 is an emitter follower circuit that includes a transistor Q96 and a capacitor C92. A collector of the transistor Q96 is connected to the power source 97, a base thereof is connected to the voltage control circuit 92, and a emitter thereof is connected to the output terminal of the second voltage adjustment circuit 96. The transistor Q96 outputs a power source voltage Vb, which is dependent on a voltage of a second voltage setting signal S_{VP-} input to the base, from the emitter. That is, the second voltage adjustment circuit 96 generates the power source voltage Vb corresponding to the value of the second voltage setting signal S_{VP-}. The power source voltage Vb can be different from the power source voltage Va.

When the voltage control circuit 92 has turned ON the first and fourth driving signals D_{Q91} and D_{Q94}, and turned OFF the second and third driving signals D_{Q92} and D_{Q93} (a first driving state), the positive power source voltage Va is applied to the primary-side circuit of the transformer T91. Also, when the voltage control circuit 92 has turned OFF the first and fourth driving signals D_{Q91} and D_{Q94}, and turned ON the second and third driving signals D_{Q92} and D_{Q93} (a second driving state), the negative power source voltage Vb is applied to the primary-side circuit of the transformer T91. As a result of repeating the above-described first driving state and second driving state of the transformer T91 alternatingly, a secondary-side circuit of the transformer T91 generates an AC voltage component Vac whose positive and negative amplitudes are different (having a so-called uneven duty waveform).

The DC output circuit 94 outputs, to one end of the secondary-side circuit of the transformer T91, a DC voltage component Vdc corresponding to the value of a DC setting signal S_{DC} input from the voltage control circuit 92. The other end of the secondary-side circuit of the transformer T91 is connected to the developing device 99 via an output terminal of the voltage generation circuit 91. Therefore, the AC output circuit 93 outputs, to the developing device 99, a developing voltage (Vdc+Vac) obtained by superimposing the AC voltage component Vac, which has been generated in the secondary-side circuit of the transformer T91, on the DC voltage component Vdc.

The circuit configuration shown in FIG. 1 leaves room for improvements in terms of the number of parts and the area of a substrate. For example, while the first voltage adjustment circuit 95 and the second voltage adjustment circuit 96 have a role in adjusting positive and negative amplitudes of the AC voltage component, a relatively large space needs to be provided between the power source 97 and the developing device 99 for the voltage adjustment circuits. Therefore, if a desired waveform can be given to the AC voltage component without providing these voltage adjustment circuits, the cost will be lowered by a reduction in the number of parts, and downsizing of the substrate will be promoted.

### 2. Exemplary Configuration of Image-Forming Apparatus

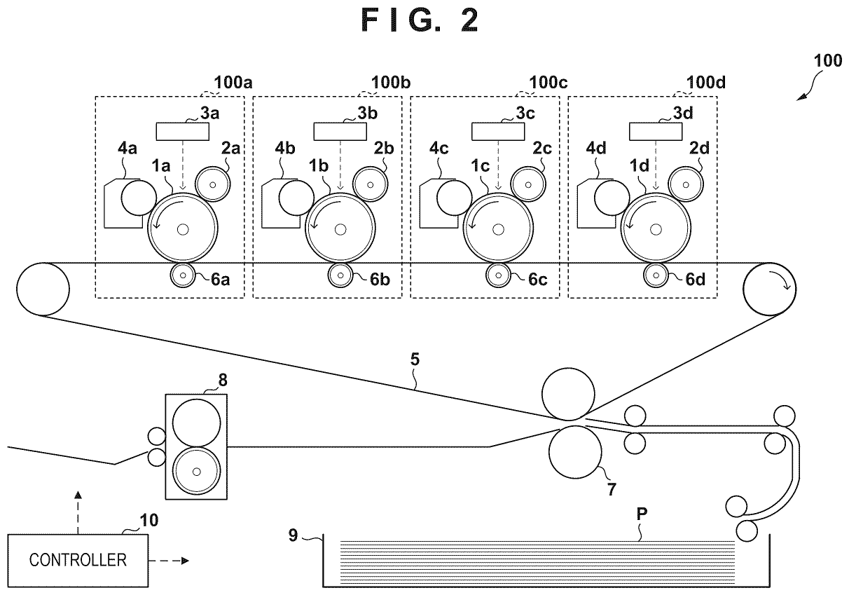

FIG. 2 is a schematic diagram showing an example of a general configuration of an image-forming apparatus 100 according to an embodiment. In the example of FIG. 2, the image-forming apparatus 100 is a color printer that forms an image using an electrophotographic method. Note that, in other embodiments, the technology according to the present disclosure may be applied to a monochrome printer.

The image-forming apparatus 100 includes image-forming units 100a, 100b, 100c, and 100d, an intermediate transfer belt 5, a secondary transfer roller 7, a fixing device 8, a cassette 9, and a controller 10. The image-forming units 100a, 100b, 100c, and 100d respectively form toner images of four color components, namely yellow (Y), magenta (M), cyan (C), and black (K). As the configurations of these image-forming units 100a, 100b, 100c, and 100d may be the same except for the differences of color components, the present description is provided using the configuration of the image-forming unit 100a as an example. Note that, in other embodiments, a color image may be formed by another combination of color components.

The image-forming unit 100a includes a photosensitive drum 1a, a charging roller 2a, a laser scanner 3a, a developing device 4a, and a primary transfer roller 6a. The photosensitive drum 1a is an image bearing member that is driven to rotate in a counterclockwise direction in the diagram. The charging roller 2a, to which a charging voltage is applied, uniformly charges a surface of the photosensitive drum 1a. The laser scanner 3a forms an electrostatic latent image on the surface of the photosensitive drum 1a by exposing the surface of the photosensitive drum 1a to laser light in accordance with an input image signal. The developing device 4a, to which a developing voltage is applied, supplies toner as a developing agent to the photosensitive drum 1a, thereby developing the electrostatic latent image borne by the photosensitive drum 1a and forming a toner image. The primary transfer roller 6a, to which a primary transfer voltage is applied, transfers the toner image formed on the surface of the photosensitive drum 1a to the intermediate transfer belt 5. The toner images of four colors formed by the image-forming units 100a, 100b, 100c, and 100d are transferred in order in a layered manner; as a result, a full-color toner image (a color image) is formed on the intermediate transfer belt 5. The intermediate transfer belt 5 conveys the color image to a secondary transfer position at which the secondary transfer roller 7 is disposed.

The cassette 9 contains a bundle of sheets. Sheets P are separated from the bundle of sheets and fed to a conveyance path from the cassette 9, one by one. A sheet P is sent to the secondary transfer position in harmony with a timing at which the color image on the intermediate transfer belt 5 arrives at the secondary transfer position. The secondary transfer roller 7, to which a secondary transfer voltage is applied, transfers the color image on the intermediate transfer belt 5 to the sheet P. The fixing device 8 causes the color image to be fixed on the sheet P by applying heat and pressure to the sheet P. The controller 10 controls the above-described image-forming operation of the image-forming apparatus 100.

The image-forming units 100a to 100d respectively include voltage generation circuits that generate a developing voltage applied to the developing devices 4a to 4d. To improve the developing performance, these voltage generation circuits output, to the developing devices 4a to 4d, a developing voltage obtained by superimposing an AC voltage component that is a square wave on a DC voltage component. The next section focuses on one of these voltage generation circuits, and describes several embodiments of a circuit configuration thereof in detail.

### 3. First Embodiment

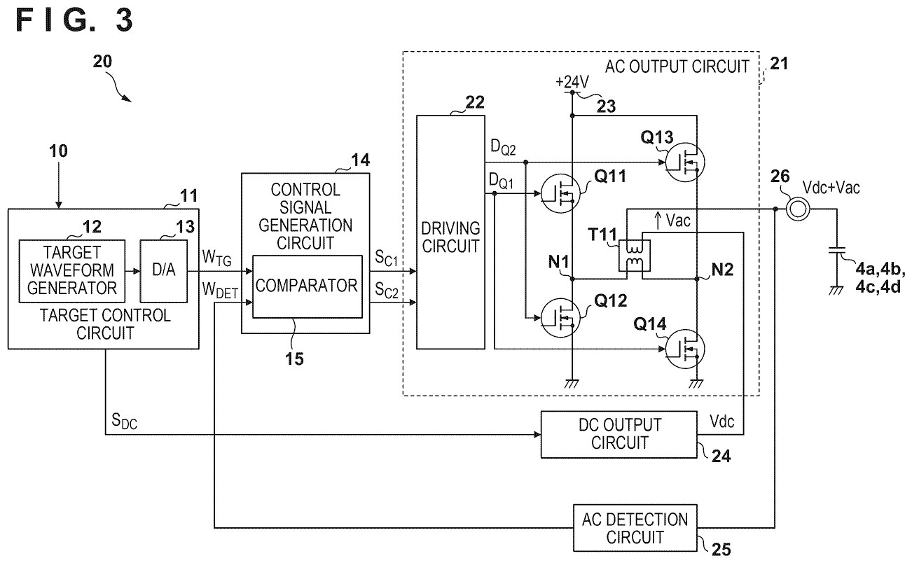

FIG. 3 is a circuit diagram showing an example of a configuration of a voltage generation circuit 20 according to the first embodiment. Referring to FIG. 3, the voltage generation circuit 20 includes a target control circuit 11, a control signal generation circuit 14, an AC output circuit 21, a DC output circuit 24, an AC detection circuit 25, and an output terminal 26. The target control circuit 11 is connected to the controller 10. The output terminal 26 is connected to the developing device 4a, 4b, 4c, or 4d.

### (1) Generation of Alternating Current (AC) Voltage Component

The AC output circuit 21 includes a transformer T11, an H-bridge circuit composed of four switches Q11, Q12, Q13, and Q14, a driving circuit 22, and a power source 23. The four switches Q11, Q12, Q13, and Q14 of the H-bridge circuit may be, for example, n-channel FETs.

The first switch Q11 and the second switch Q12 of the H-bridge circuit are connected to a first terminal N1 of a primary-side circuit of the transformer. More specifically, a source of the first switch Q11 is connected to a first terminal N1, a drain thereof is connected to the power source 23, and a gate thereof is connected to the driving circuit 22. A voltage of the power source 23 is, for example, +24 V. A source of the second switch Q12 is grounded, a drain thereof is connected to the first terminal N1, and a gate thereof is connected to the driving circuit 22.

The third switch Q13 and the fourth switch Q14 of the H-bridge circuit are connected to a second terminal N2 of the primary-side circuit of the transformer. More specifically, a source of the third switch Q13 is connected to the second terminal N2, a drain thereof is connected to the power source 23, and a gate thereof is connected to the driving circuit 22. A source of the fourth switch Q14 is grounded, a drain thereof is connected to the second terminal N2, and a gate thereof is connected to the driving circuit 22.

That is, in the present embodiment, the first switch Q11 and the third switch Q13 at the high side of the H-bridge circuit of the AC output circuit 21 are connected directly to the power source 23 without intervention of the voltage adjustment circuits shown in FIG. 1. The same goes for second and third embodiments, as described herein.

Based on a first control signal S_{C1} input from the control signal generation circuit 14, the driving circuit 22 outputs a first driving signal D_{Q1} that controls ON and OFF of the first switch Q11 and the fourth switch Q14 to the gate of the first switch Q11 and the gate of the fourth switch Q14. For example, the driving circuit 22 may generate the first driving signal D_{Q1} by amplifying the first control signal S_{C1}. The first switch Q11 and the fourth switch Q14 switch to an electrically conductive state when the first driving signal D_{Q1} becomes a high level.

Also, based on a second control signal S_{C2} input from the control signal generation circuit 14, the driving circuit 22 outputs the second driving signal D_{Q2} that controls ON and OFF of the second switch Q12 and the third switch Q13 to the gate of the second switch Q12 and the gate of the third switch Q13. For example, the driving circuit 22 may generate the second driving signal D_{Q2} by amplifying the second control signal S_{C2}. The second switch Q12 and the third switch Q13 switch to an electrically conductive state when the second driving signal D_{Q2} becomes a high level. The first driving signal D_{Q1} and the second driving signal D_{Q2} are not concurrently placed in an ON state at any time.

The driving circuit 22 may include a bootstrap circuit for supplying a voltage greater than +24 V to the gates of the first switch Q11 and the third switch Q13 at the high side of the H-bridge circuit.

When the first driving signal D_{Q1} has turned ON the first switch Q11 and the fourth switch Q14 in a period in which the AC component of the developing voltage is supposed to be positive, and the second driving signal D_{Q2} has turned OFF the second switch Q12 and the third switch Q13 in the same period, a positive voltage of 24 V is applied to the primary-side circuit of the transformer T11. Also, when the first driving signal D_{Q1} has turned OFF the first switch Q11 and the fourth switch Q14 in a period in which the AC component of the developing voltage is supposed to be negative, and the second driving signal D_{Q2} has turned ON the second switch Q12 and the third switch Q13 in the same period, a negative voltage of −24 V is applied to the primary-side circuit of the transformer T11. In this case, the absolute values of the positive and negative voltages are equal. On the other hand, in the present embodiment, a duty ratio between a time in which a positive voltage is applied to the primary-side circuit of the transformer T11 as a result of the first driving signal D_{Q1} providing an instruction for intermittent ON to make the AC component of the developing voltage positive, and a period in which a negative voltage is applied to this primary-side circuit as a result of the second driving signal D_{Q2} providing an instruction for intermittent ON to make the AC component of the developing voltage negative, is variably controlled. Then, an AC voltage component Vac having a positive amplitude dependent on a duty ratio of the first driving signal D_{Q1} and a negative amplitude dependent on a duty ratio of the second driving signal D_{Q2}, are generated in the secondary-side circuit of the transformer T11. Specifically, the higher the duty ratio of the first driving signal D_{Q1}, the larger the positive amplitude of the AC voltage component Vac (approaches +24 V); the higher the duty ratio of the second driving signal D_{Q2}, the larger the negative amplitude of the AC voltage component Vac (approaches −24 V). The control signal generation circuit 14, which will be described below, outputs the first control signal S_{C1} and the second control signal S_{C2} that are generated so that these positive and negative amplitudes of the AC voltage component Vac approach target values to the driving circuit 22.

### (2) Outputting of Developing Voltage

The DC output circuit 24 outputs, to one end of the secondary-side circuit of the transformer T11, a DC voltage component Vdc with a magnitude dependent on a DC setting signal S_{DC} input from the target control circuit 11. The other end of the secondary-side circuit of the transformer T11 is connected to the output terminal 26. Therefore, the AC voltage component Vac output from the AC output circuit 21 is superimposed on the DC voltage component Vdc output from the DC output circuit 24. The voltage generation circuit 20 outputs a developing voltage Vdc+Vac generated in the foregoing manner, which is equal to a sum of the DC voltage component Vdc and the AC voltage component Vac, to the developing device 4a, 4b, 4c, or 4d via the output terminal 26.

### (3) Generation of Target Waveform

The target control circuit 11 includes a target waveform generator 12 and a digital/analog (D/A) converter 13. The target waveform generator 12 performs serial communication with the controller 10. The target waveform generator 12 receives a command for generating a target waveform from the controller 10.

The target waveform denotes a waveform that resembles a waveform of a developing voltage that is supposed to be applied to the developing device 4a, 4b, 4c, or 4d. The target waveform may be a sum of an AC voltage component that is a square wave, and a DC voltage component indicating a certain voltage, similarly to the waveform of the developing voltage. The frequency of an AC voltage component of the target waveform is equal to the frequency of the AC voltage component of the developing voltage. The controller 10 may control the target waveform to suppress a decrease in the developing performance of the developing devices caused by a change in an operating condition of the image-forming apparatus 100 (e.g., a change in an environmental condition, such as a temperature and humidity, or deterioration of a member associated with a long-term use). For example, the higher the possibility of occurrence of image quality deterioration, such as a ring mark and a white void, the larger the target control circuit 11 may set the negative amplitude of the AC voltage component of the target waveform.

The controller 10 can provide the target waveform generator 12 with, for example, waveform information indicating a magnitude of a DC voltage component of the target waveform, and a positive amplitude, a negative amplitude, and a frequency of the AC voltage component thereof. In response to a command from the controller 10, the target waveform generator 12 generates a digital signal that is a pseudo representation of the target waveform, and outputs the generated digital signal to the D/A converter 13. The D/A converter 13 generates a target voltage signal W_{TG} by converting a signal format of the digital signal input from the target waveform generator 12 from a digital format to an analog format. The target control circuit 11 outputs the target voltage signal W_{TG} generated by the D/A converter 13 to the control signal generation circuit 14. Furthermore, the target control circuit 11 outputs the DC setting signal S_{DC} indicating a magnitude of the DC voltage component of the developing voltage to the DC output circuit 24.

### (4) Control on Duty Ratio

The AC detection circuit 25 detects the AC voltage component of the developing voltage output from the voltage generation circuit 20 to the developing device 4a, 4b, 4c, or 4d, and outputs a detected voltage signal W_{DET} indicating a waveform of this detected AC voltage component to the control signal generation circuit 14.

The control signal generation circuit 14 generates a first control signal S_{C1} and a second control signal S_{C2} based on comparison between the target voltage signal W_{TG} from the target control circuit 11 and the detected voltage signal W_{DET} from the AC detection circuit 25. The first control signal S_{C1} is a sequence of pulse signals providing an instruction for turning ON or OFF the first switch Q11 and the fourth switch Q14. The second control signal S_{C2} is a sequence of pulse signals providing an instruction for turning ON or OFF the second switch Q12 and the third switch Q13. A width of an ON period and a width of an OFF period of each cycle of these pulse signals vary.

In the present embodiment, the control signal generation circuit 14 may include or be implemented as a comparator 15. The comparator 15 can decide signal levels of the first control signal S_{C1} and the second control signal S_{C2} in accordance with a control logic of the following Table 1 based on comparison between the target voltage signal W_{TG} and the detected voltage signal W_{DET}, for example.

TABLE 1

| | First Control | Second Control |
|---|---|---|
| Condition | Signal S_{C1} | Signal S_{C2} |
| W_{TG} > W_{DET} | HIGH | LOW |
| W_{TG} ≤ W_{DET} | LOW | HIGH |

According to Table 1, in a case where the target voltage signal W_{TG} indicates a voltage greater than the detected voltage signal W_{DET}, the first control signal S_{C1} becomes a high level and provides an instruction for turning ON the first switch Q11 and the fourth switch Q14. Also, in a case where the target voltage signal W_{TG} indicates a voltage less than the detected voltage signal W_{DET}, the first control signal S_{C1} becomes a low level and provides an instruction for turning OFF the first switch Q11 and the fourth switch Q14. In a case where the target voltage signal W_{TG} indicates a voltage less than the detected voltage signal W_{DET}, the second control signal S_{C2} becomes a high level and provides an instruction for turning ON the second switch Q12 and the third switch Q13. Also, in a case where the target voltage signal W_{TG} indicates a voltage greater than the detected voltage signal W_{DET}, the second control signal S_{C2} becomes a low level and provides an instruction for turning OFF the second switch Q12 and the third switch Q13. In this example, the first control signal S_{C1} and the second control signal S_{C2} are sequences of pulse signals that are inverted relative to each other.

For example, assume that the developing voltage is maintained at Vₚ₊ and Vₚ₋ in a high-level section and a low-level section (Vₚ₊>Vdc>Vₚ₋), respectively, and the target voltage signal W_{TG} indicates voltages V1 and V2 in the high-level section and the low-level section (V1>V2), respectively. At the rise of the target voltage signal W_{TG}, the target voltage signal W_{TG} changes from V2 to V1, and W_{TG}>W_{DET} holds until the detected voltage signal W_{DET} catches up to this change. Then, the first control signal Sci and the second control signal S_{C2} respectively provide instructions for ON and OFF, a positive voltage is applied to the primary-side circuit of the transformer T11 of the AC output circuit 21, and the duty ratio of the positive voltage increases; as a result, the AC voltage component Vac of the developing voltage rises. When the AC voltage component Vac eventually exceeds V1 due to overshoot, W_{TG}≤W_{DET} holds. Then, the first control signal S_{C1} and the second control signal S_{C2} respectively provide instructions for OFF and ON, a negative voltage is applied to the primary-side circuit of the transformer T11 of the AC output circuit 21, and the duty ratio of the negative voltage increases; as a result, the AC voltage component Vac of the developing voltage drops. When the AC voltage component Vac eventually falls below V1 due to undershoot, W_{TG}>W_{DET} holds. Then, the first control signal S_{C1} and the second control signal S_{C2} respectively provide instructions for ON and OFF, and a positive voltage is applied to the primary-side circuit of the transformer T11 of the AC output circuit 21 again. While the target voltage signal W_{TG} is maintained at V1, the two control signals S_{C1} and S_{C2} repeats such ON and OFF at high speed; as a result, in the high-level section, the AC voltage component Vac is maintained at the vicinity of the target value while exhibiting pulsation. The same goes for the fall of the target voltage signal W_{TG} and the low-level section that follows it.

An ideal frequency of the AC voltage component of the developing voltage is, for example, approximately 12 kHz. Meanwhile, the speed of a response to a feedback of the aforementioned detected voltage signal W_{DET} is generally sufficiently faster than 12 kHz. Therefore, a control deviation, which becomes largest immediately after the rise at the beginning of a high-level section and the fall at the beginning of a low-level section, attenuates in the middle of each section, and the developing voltage converges on a certain target value in the middle of each section. In the present embodiment, the pulsation, i.e., repetition of a small positive difference and negative difference from the target value of the developing voltage, is converted into pulses of the first control signal S_{C1} and the second control signal S_{C2} as is. Therefore, both of the first control signal S_{C1} and the second control signal S_{C2} repeat ON and OFF throughout the entire cycle of the AC voltage component Vac, and the amplitude of the AC voltage component Vac is controlled based on the width of the ON period and the width of the OFF period in each pulse cycle.

### (5) Examples of Temporal Transitions of Signal Levels

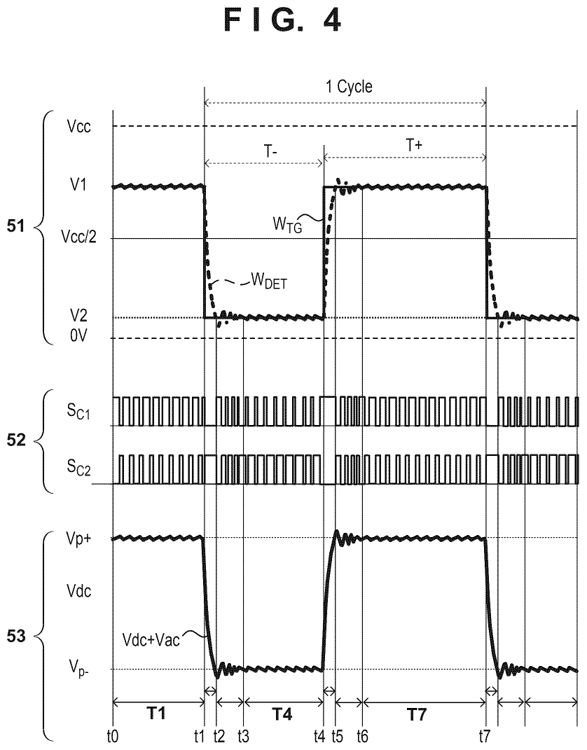

FIG. 4 is a time chart showing examples of transitions of signal levels of several signals according to the present embodiment. A portion 51 of the chart shows examples of transitions of the target voltage signal W_{TG} and the detected voltage signal W_{DET}. A portion 52 of the chart shows examples of transitions of the first control signal S_{C1} and the second control signal S_{C2}. A portion 53 of the chart shows an example of a transition of the developing voltage output from the AC output circuit 21.

The target voltage signal W_{TG}, which is indicated by a solid line in the portion 51 of the chart, is a square wave that repeats a cycle composed of a low-level section of a length T− and a high-level section of a length T+. In the examples shown, a period between times t1 and t4 corresponds to one low-level section, and the voltage of the target voltage signal W_{TG} is equal to V2 in the low-level section. In the present embodiment, T−<T+. Also, a period between times t4 and t7 corresponds to one high-level section, and the voltage of the target voltage signal W_{TG} is equal to V1 in the high-level section. On the other hand, the detected voltage signal W_{DET}, which is indicated by a dash line, is a substantially square wave that repeats ON and OFF, following the fall and the rise of the target voltage signal W_{TG}. In the examples shown, the detected voltage signal W_{DET} reaches the low level (V2) at time t2, lagging behind the fall of the target voltage signal W_{TG} at time t1. From time t3 to time t4, the detected voltage signal W_{DET} is maintained at the vicinity of the low level, which is the target value, while exhibiting pulsation. Also, the detected voltage signal W_{DET} reaches the high level (V1) at time t5, lagging behind the rise of the target voltage signal W_{TG} at time t4. From time t6 to time t7, the detected voltage signal W_{DET} is maintained at the vicinity of the high level, which is the target value, while exhibiting pulsation.

The range of the voltages of the target voltage signal W_{TG} and the detected voltage signal W_{DET} is, for example, 0-V_{CC} [V], and V_{CC} is decided based on a power source voltage of a control system. V_{CC}/2, which corresponds to the center of this range, corresponds to the origin of the AC voltage component Vac. In other words, a voltage greater than V_{CC}/2 corresponds to a positive voltage of the AC voltage component Vac, and a voltage less than V_{CC}/2 corresponds to a negative voltage value of the AC voltage component Vac.

The first control signal S_{C1} shown in the portion 52 of the chart indicates a high level in a period in which the target voltage signal W_{TG} of the portion 51 of the chart is larger than the detected voltage signal W_{DET}, and a low level in a period in which the target voltage signal W_{TG} is smaller than the detected voltage signal W_{DET}. The second control signal S_{C2} indicates a high level in a period in which the target voltage signal W_{TG} is less than the detected voltage signal W_{DET}, and a low level in a period in which the target voltage signal W_{TG} is greater than the detected voltage signal W_{DET}.

The developing voltage Vdc+Vac shown in the portion 53 of the chart is a sum of the DC voltage component Vdc and the AC voltage component Vac. In the examples shown, the positive amplitude and the negative amplitude of the AC voltage component Vac are equal to |Vₚ₊- Vdc| and |Vdc-Vₚ₋|, respectively, and the negative amplitude is greater than the positive amplitude.

### (6) Summary of First Embodiment

According to the above-described first embodiment, two switch pairs of the H-bridge circuit are turned ON and OFF at high speed through feedback control based on comparison between a target voltage signal and a detected voltage signal that indicates a detection result of an AC voltage component of an output voltage to a developing device. In this way, the duty ratio between a period in which a positive voltage is applied to the primary-side circuit of the transformer and a period in which a negative voltage is applied thereto can be changed while following the target voltage signal, and an AC voltage component with desired positive and negative amplitudes can be generated in the secondary-side circuit of the transformer.

Especially, the configuration of the voltage generation circuit 20 according to the first embodiment does not require voltage adjustment circuits that have existed in a conventional circuit configuration for causing positive and negative amplitudes of an AC component of a developing voltage to be different from each other. Therefore, the number of parts in an apparatus is reduced, the manufacturing cost is lowered, and at the same time, downsizing of a substrate is promoted.

For the purpose of preventing image quality deterioration that occurs in a toner image, such as a ring mark and a white void, the target value of the negative amplitude of the AC voltage component can be set at a value greater than the target value of the positive amplitude thereof. However, the technology according to the present disclosure is not limited to this example. The target value of the negative amplitude of the AC voltage component may be set at a value that is equal to or smaller than the target value of the positive amplitude thereof.

Note that in the example of FIG. 3, although the control signal generation circuit 14 is an analog circuit that compares a target voltage signal and a detected voltage signal that are both analog signals, the control signal generation circuit 14 may be configured as a digital circuit that compares digital signals. In this case, the D/A converter 13 in the target control circuit 11 is omitted and, instead, an analog/digital (A/D) conversion may be applied to the detected voltage signal from the AC detection circuit 25.

### 4. Second Embodiment

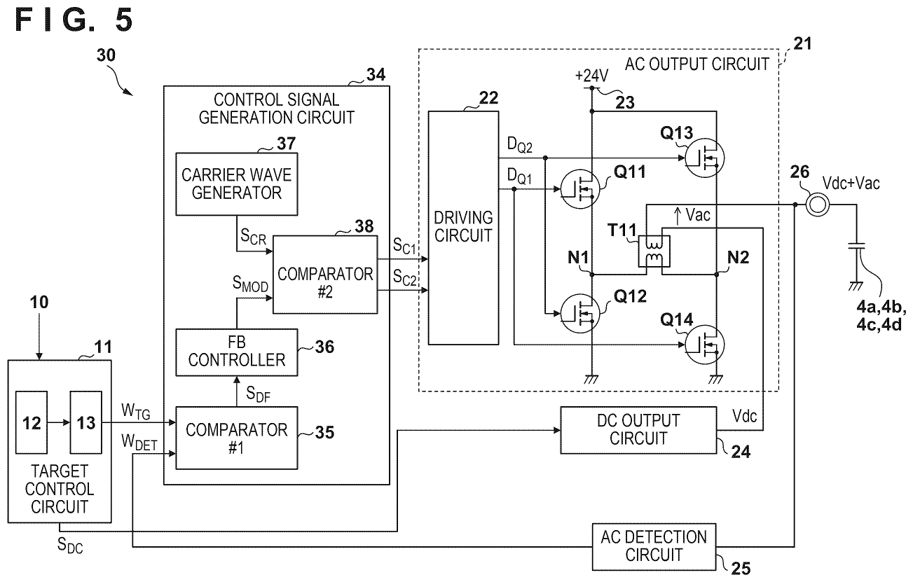

FIG. 5 is a circuit diagram showing an example of a configuration of a voltage generation circuit 30 according to a second embodiment. Referring to FIG. 5, the voltage generation circuit 30 includes a target control circuit 11, a control signal generation circuit 34, an AC output circuit 21, a DC output circuit 24, an AC detection circuit 25, and an output terminal 26. The target control circuit 11 is connected to the controller 10. The output terminal 26 is connected to the developing device 4a, 4b, 4c, or 4d.

The configurations of the target control circuit 11, AC output circuit 21, DC output circuit 24, and AC detection circuit 25 according to the second embodiment may be similar to the configurations according to the first embodiment described in the previous section and are incorporated herein by reference for conciseness.

### (1) Duty Ratio Control

The control signal generation circuit 34 generates a first control signal S_{C1} and a second control signal S_{C2} based on comparison between a target voltage signal W_{TG} from the target control circuit 11 and a detected voltage signal W_{DET} from the AC detection circuit 25. The first control signal S_{C1} is a sequence of pulse signals providing an instruction for turning ON or OFF the first switch Q11 and the fourth switch Q14. The second control signal S_{C2} is a sequence of pulse signals providing an instruction for turning ON or OFF the second switch Q12 and the third switch Q13. Similarly to the first embodiment, the pulse widths of these pulse signals are variable, and the positive and negative amplitudes of an AC voltage component Vac output from the AC output circuit 21 are controlled through pulse width modulation (PWM). In the first embodiment, a switching cycle for two control signals is passively decided depending on deviations of the detected voltage signal W_{DET} relative to the target voltage signal W_{TG}; however, in the second embodiment, a switching cycle for two control signals is actively set as a cycle of a below-described carrier signal S_{CR}.

In the present embodiment, the control signal generation circuit 34 performs more advanced feedback control to suppress output ripple or other noises that appear in a developing voltage output to the developing device. The control signal generation circuit 34 includes a first comparator 35, a feedback (FB) controller 36, a carrier wave generator 37, and a second comparator 38.

The first comparator 35 calculates deviations of the detected voltage signal W_{DET} relative to the target voltage signal W_{TG}, and outputs a deviation signal S_{DF} indicating the calculated deviations to the FB controller 36.

Through feedback control based on the deviations indicated by the deviation signal S_{DF} (e.g., PI control or PID control), the FB controller 36 outputs a modulated voltage signal S_{MOD} that has been modulated to eliminate the deviations of the detected voltage signal W_{DET} relative to the target voltage signal W_{TG}. The FB controller 36 applies at least proportion (P) control that uses a proportion gain, and integration (I) control that includes multiplication of an accumulated value of the deviations by an integration gain, with respect to the deviations indicated by the deviation signal S_{DF}. The FB controller 36 may further apply differentiation (D) control that uses a differentiation gain. The values of these gains are decided through tuning and incorporated in the FB controller 36 in advance.

The carrier wave generator 37 generates a carrier signal S_{CR} with a frequency that is sufficiently greater than a frequency of the AC voltage component Vac that is supposed to be generated by the AC output circuit 21. For example, the frequency of the AC voltage component Vac may be approximately 12 kHz as stated earlier, and the frequency of the carrier signal S_{CR} may be approximately 100 MHz. In the present embodiment, the carrier signal S_{CR} may be a triangle wave that repeats a linear voltage rise and fall between 0 V and the maximum voltage V_{CC}.

The second comparator 38 generates the first control signal S_{C1} and the second control signal S_{C2} based on comparison between the modulated voltage signal S_{MOD} from the FB controller 36 and the carrier signal S_{CR} from the carrier wave generator 37. The second comparator 38 can decide signal levels of the first control signal S_{C1} and the second control signal S_{C2} in accordance with a control logic of the following Table 2, for example.

TABLE 2

| | First Control | Second Control |
|---|---|---|
| Condition | Signal S_{C1} | Signal S_{C2} |
| S_{MOD} > S_{CR} | HIGH | LOW |
| S_{MOD} ≤ S_{CR} | LOW | HIGH |

According to Table 2, in a case where the modulated voltage signal S_{MOD} indicates a voltage greater than the carrier signal S_{CR}, the first control signal S_{C1} becomes a high level and provides an instruction for turning ON the first switch Q11 and the fourth switch Q14. Also, in a case where the modulated voltage signal S_{MOD} indicates a voltage less than the carrier signal S_{CR}, the first control signal S_{C1} becomes a low level and provides an instruction for turning OFF the first switch Q11 and the fourth switch Q14. In a case where the modulated voltage signal S_{MOD} indicates a voltage less than the carrier signal S_{CR}, the second control signal S_{C2} becomes a high level and provides an instruction for turning ON the second switch Q12 and the third switch Q13. Also, in a case where the modulated voltage signal S_{MOD} indicates a voltage greater than the carrier signal S_{CR}, the second control signal S_{C2} becomes a low level and provides an instruction for turning OFF the second switch Q12 and the third switch Q13. In this example, the first control signal S_{C1} and the second control signal S_{C2} are sequences of pulse signals that are inverted relative to each other.

### (2) Examples of Temporal Transitions of Signal Levels

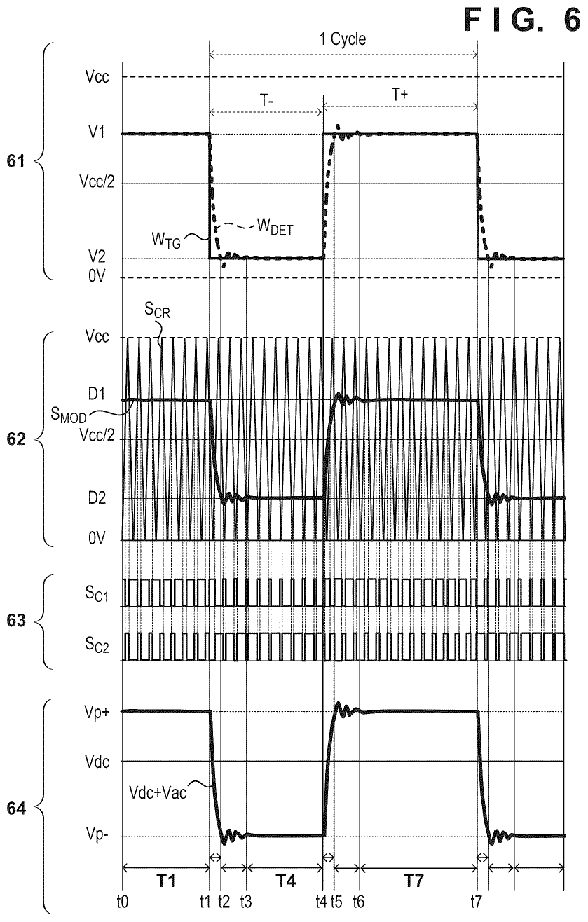

FIG. 6 is a time chart showing examples of transitions of signal levels of several signals according to the present embodiment. Portion 61 of the chart shows examples of transitions of the target voltage signal W_{TG} and the detected voltage signal W_{DET}. Portion 62 of the chart shows examples of transitions of the modulated voltage signal S_{MOD} and the carrier signal S_{CR}. Portion 63 of the chart shows examples of transitions of the first control signal S_{C1} and the second control signal S_{C2}. Portion 64 of the chart shows an example of a transition of the developing voltage output from the AC output circuit 21.

The target voltage signal W_{TG}, which is indicated by a solid line in the chart 61, is a square wave that repeats a cycle composed of a low-level section of a length T− and a high-level section of a length T+. In the present embodiment, T−<T+. In the examples shown, a period between times t1 and t4 corresponds to one low-level section, and the voltage of the target voltage signal W_{TG} is equal to V2 in the low-level section. Also, a period between times t4 and t7 corresponds to one high-level section, and the voltage of the target voltage signal W_{TG} is equal to V1 in the high-level section. On the other hand, the detected voltage signal W_{DET}, which is indicated by a dash line, is a substantially square wave that repeats ON and OFF, following the fall and the rise of the target voltage signal W_{TG}. In the examples shown, the detected voltage signal W_{DET} reaches the low level (V2) at time t2, lagging behind the fall of the target voltage signal W_{TG} at time t1, and converges at time t3. Also, the detected voltage signal W_{DET} reaches the high level (V1) at time t5, lagging behind the rise of the target voltage signal W_{TG} at time t4, and converges at time t6.

The range of the voltages of the target voltage signal W_{TG} and the detected voltage signal W_{DET} is, for example, 0-V_{CC} [V], and V_{CC} is decided based on a power source voltage of a control system. V_{CC}/2, which corresponds to the center of this range, corresponds to the origin of the AC voltage component Vac. In other words, a voltage greater than V_{CC}/2 corresponds to a positive voltage of the AC voltage component Vac, and a voltage less than V_{CC}/2 corresponds to a negative voltage value of the AC voltage component Vac.

The modulated voltage signal S_{MOD} shown in the portion 62 of the chart is a signal generated by the FB controller 36 as a result of the aforementioned PI control or PID control based on deviations of the detected voltage signal W_{DET} relative to the target voltage signal W_{TG}. The modulated voltage signal S_{MOD} follows variation of the target voltage signal W_{TG} and the detected voltage signal W_{DET}, and indicates a voltage in the vicinity of a voltage D2 in a low-level section, and a voltage in the vicinity of a voltage D1 in a high-level section. The carrier signal S_{CR} is a triangle wave that moves back and forth between a voltage of zero and the maximum voltage V_{CC} in a cycle that is sufficiently shorter than a cycle of the target voltage signal W_{TG}.

The first control signal S_{C1} shown in the portion 63 of the chart indicates a high level in a period in which the modulated voltage signal S_{MOD} of the portion 62 of the chart is larger than the carrier signal S_{CR}, and a low level in a period in which the modulated voltage signal S_{MOD} is smaller than the carrier signal S_{CR}. The duty ratio of the first control signal S_{C1} is 100% in a case where the modulated voltage signal S_{MOD} is equal to V_{CC}, 50% in a case where the modulated voltage signal S_{MOD} is equal to V_{CC}/2, and 0% in a case where the modulated voltage signal S_{MOD} is equal to a voltage of zero. The second control signal S_{C2} indicates a high level in a period in which the modulated voltage signal S_{MOD} is smaller than the carrier signal S_{CR}, and a low level in a period in which the modulated voltage signal S_{MOD} is larger than the carrier signal S_{CR}. The duty ratio of the second control signal S_{C2} is 0% in a case where the modulated voltage signal S_{MOD} is equal to V_{CC}, 50% in a case where the modulated voltage signal S_{MOD} is equal to V_{CC}/2, and 100% in a case where the modulated voltage signal S_{MOD} is equal to a voltage of zero.

The developing voltage Vdc+Vac shown in the portion 64 of the chart is a sum of the DC voltage component Vdc and the AC voltage component Vac. In the examples shown, the positive amplitude and the negative amplitude of the AC voltage component Vac are equal to |Vₚ₊-Vdc| and |Vdc-Vₚ₋|, respectively, and the negative amplitude is greater than the positive amplitude.

The following describes transitions of signal levels in more detail in chronological order. In a period T1 between times t0 to t1, the target voltage signal W_{TG} belongs to a high-level section, and steadily indicates a voltage of V1. In the period T1, the modulated voltage signal S_{MOD} steadily indicates a voltage of D1 as a result of feedback control; in response, the duty ratio of the first control signal S_{C1} becomes approximately 0.7, and the duty ratio of the second control signal S_{C2} becomes approximately 0.3. This means that the percentage of a period in which a positive voltage (24 V) is applied to the primary-side circuit of the transformer T11 becomes approximately 70%, and the percentage of a period in which a negative voltage (−24 V) is applied to the primary-side circuit of the transformer T11 becomes approximately 30%. At this time, a time average of the applied voltages in the primary-side circuit has a positive value, and a voltage generated in the secondary-side circuit of the transformer T11 has a positive value (Vₚ₊-Vdc). As a result, the voltage generation circuit 30 outputs a developing voltage indicating a voltage of Vₚ₊.

At time t1, the target voltage signal W_{TG} transitions to a low-level section, and the voltage thereof changes from V1 to V2. Then, the target voltage signal W_{TG} falls below the detected voltage signal W_{DET}; accordingly, the modulated voltage signal S_{MOD} starts to drop as a result of feedback control. In response, the duty ratio of the first control signal S_{C1} decreases, but on the other hand, the duty ratio of the second control signal S_{C2} increases. As a result, the developing voltage output from the voltage generation circuit 30 drops from Vₚ₊ to Vₚ₋.

At time t2, the developing voltage output from the voltage generation circuit 30 drops (undershoots) past Vₚ₋, which is the target value, and oscillates around Vₚ₋. At time t3, the developing voltage converges on (stabilizes at) Vₚ₋.

In a period T4 between times t3 to t4, the target voltage signal W_{TG} belongs to a low-level section, and steadily indicates a voltage of V2. In the period T4, the modulated voltage signal S_{MOD} steadily indicates a voltage of D2 as a result of feedback control; in response, the duty ratio of the first control signal S_{C1} becomes approximately 0.2, and the duty ratio of the second control signal S_{C2} becomes approximately 0.8. This means that the percentage of a period in which a positive voltage (24 V) is applied to the primary-side circuit of the transformer T11 becomes approximately 20%, and the percentage of a period in which a negative voltage (−24 V) is applied to the primary-side circuit of the transformer T11 becomes approximately 80%. At this time, a time average of the applied voltages in the primary-side circuit has a negative value, and a voltage generated in the secondary-side circuit of the transformer T11 has a negative value (Vₚ₋- Vdc). As a result, the voltage generation circuit 30 outputs a developing voltage indicating a voltage of Vₚ₋.

At time t4, the target voltage signal W_{TG} transitions to a high-level section, and the voltage thereof changes from V2 to V1. Then, the target voltage signal W_{TG} exceeds the detected voltage signal W_{DET}; accordingly, the modulated voltage signal S_{MOD} starts to rise as a result of feedback control. In response, the duty ratio of the first control signal S_{C1} increases, but on the other hand, the duty ratio of the second control signal S_{C2} decreases. As a result, the developing voltage output from the voltage generation circuit 30 rises from Vₚ₋ to Vₚ₊.

At time t5, the developing voltage output from the voltage generation circuit 30 rises (overshoots) past Vₚ₊, which is the target value, and oscillates around Vₚ₊. At time t6, the developing voltage converges on (stabilizes at) Vₚ₊.

In the following period T7 between times t6 and t7, and in the subsequent periods, the transitions of signal levels of respective signals are similar to the transitions that have been described in connection with times t0 to t6.

### (3) Summary of Second Embodiment

According to the above-described second embodiment, two switch pairs of the H-bridge circuit are turned ON and OFF at high speed through feedback control based on comparison between a target voltage signal and a detected voltage signal that indicates a detection result of an AC voltage component of an output voltage to a developing device. In this way, the duty ratio between a period in which a positive voltage is applied to the primary-side circuit of the transformer and a period in which a negative voltage is applied thereto can be adjusted while following the target voltage signal, and an AC voltage component with desired positive and negative amplitudes can be generated in the secondary-side circuit of the transformer.

Furthermore, according to the second embodiment, the cycle of ON and OFF of two switch pairs of the H-bridge circuit are actively set as a cycle of a carrier signal. Therefore, compared to the first embodiment in which a switching cycle for control pulses is passively decided, the ability of the developing voltage to track the target waveform can be enhanced in the second embodiment. In addition, in the second embodiment, it is easy to design an apparatus such that the switching cycle is optimized in terms of suppression of noises in the developing voltage, such as output ripple, or suppression of an increase in the temperature of parts.

In the second embodiment, although the configuration of the control signal generation circuit is more complex, voltage adjustment circuits for causing positive and negative amplitudes of an AC component of a developing voltage to be different from each other is not required inside the AC output circuit 21 that handles a high voltage, similarly to the first embodiment. Therefore, the manufacturing cost of the apparatus can be lowered, and at the same time, the degree of freedom of a circuit design can be enhanced to promote downsizing of a substrate.

### 5. Third Embodiment

The aforementioned control of a duty ratio for generating a desired AC voltage component of a developing voltage may be realized without deviation feedback according to the first embodiment and the second embodiment. In a third embodiment, which is described in this section, a voltage generation circuit 40 generates a developing voltage having a desired AC voltage component through so-called open control that uses a sequence of control signals that have been decided and stored in a memory in advance, instead of feedback of deviations relative to a target.

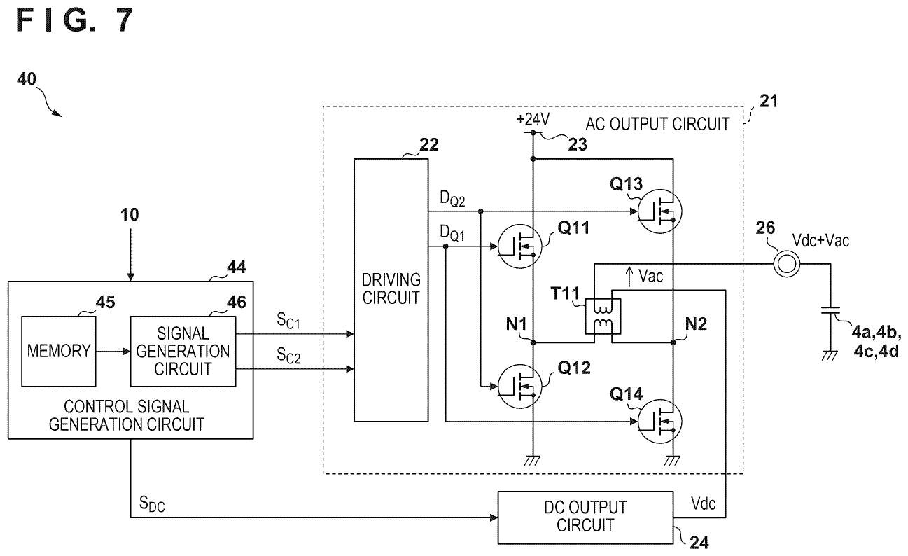

FIG. 7 is a circuit diagram showing an example of a configuration of a voltage generation circuit 40 according to the third embodiment. Referring to FIG. 7, the voltage generation circuit 40 includes a control signal generation circuit 44, an AC output circuit 21, a DC output circuit 24, and an output terminal 26. The control signal generation circuit 44 is connected to the controller 10. The output terminal 26 is connected to the developing device 4a, 4b, 4c, or 4d.

The configurations of the AC output circuit 21 and the DC output circuit 24 according to the third embodiment may be similar to the configurations in the above-described first and second embodiments.

The control signal generation circuit 44 includes a memory 45 and a signal generation circuit 46. The signal generation circuit 46 performs serial communication with the controller 10.

First waveform information and second waveform information are stored in the memory 45 in advance. The first waveform information defines an ideal signal waveform of a first driving signal D_{Q1} that is supposed to be output from the driving circuit 22 to a first switch Q11 and a fourth switch Q14. The second waveform information defines an ideal signal waveform of a second driving signal D_{Q2} that is supposed to be output from the driving circuit 22 to a second switch Q12 and a third switch Q13. As each of the first driving signal D_{Q1} and the second driving signal D_{Q2} is a sequence of pulse signals, the first waveform information and the second waveform information define at least the timings of ON and OFF of each signal. It is assumed that the frequency of switching of pulse signals is sufficiently greater than the frequency of the desired AC voltage component of the developing voltage. Ideal signal waveforms of the first driving signal D_{Q1} and the second driving signal D_{Q2} can be decided through, for example, an experiment on a product before shipment.

In response to a command from the controller 10, the signal generation circuit 46 reads out the first waveform information and the second waveform information from the memory 45, generates a first control signal S_{C1} in accordance with the first waveform information, and generates a second control signal S_{C2} in accordance with the second waveform information. Then, the signal generation circuit 46 outputs the generated first control signal S_{C1} and the second control signal S_{C2} to the driving circuit 22. Furthermore, the signal generation circuit 46 outputs a DC setting signal S_{D}C indicating a magnitude of a DC voltage component of the developing voltage to the DC output circuit 24.

The driving circuit 22 generates the first driving signal D_{Q1} by amplifying the first control signal S_{C1}, and outputs the first driving signal D_{Q1} to the first switch Q11 and the fourth switch Q14. Also, the driving circuit 22 generates the second driving signal D_{Q2} by amplifying the second control signal S_{C2}, and outputs the second driving signal D_{Q2} to the second switch Q12 and the third switch Q13.

In the present embodiment, the signal waveforms of the first control signal Sci and the second control signal S_{C2} may be the waveforms exemplarily shown in the portion 52 of the chart in FIG. 4 or the portion 63 of the chart in FIG. 6. Either of the signal waveforms indicates a series of pulses that repeats ON and OFF of a pulse for PWM throughout the entire cycle of the AC voltage component Vac, and the frequency of PWM control therefor is sufficiently greater than the frequency of the AC voltage component Vac. The waveforms of the first driving signal D_{Q1} and the second driving signal D_{Q2} resemble the waveforms of the first control signal S_{C1} and the second control signal S_{C2}, and only signal levels thereof can be different as a result of amplification. As opposed to the first and second embodiments in which the waveforms of these control signals and driving signals are variable through feedback control, the waveforms of these control signals and driving signals are fixed in the present embodiment.

In the present embodiment, the duty ratio between a period in which a positive voltage is applied to the primary-side circuit of the transformer T11 and a period in which a negative voltage is applied to this primary-side circuit is determined by defining signal sequences beforehand. An AC voltage component Vac with an amplitude dependent on this duty ratio is generated in the secondary-side circuit of the transformer T11. The voltage generation circuit 40 outputs a developing voltage Vdc+Vac, which is equal to a sum of the DC voltage component Vdc output from the DC output circuit 24 and this AC voltage component Vac, to the developing device 4a, 4b, 4c, or 4d via the output terminal 26.

In an embodiment example, a plurality of sets of first waveform information and second waveform information that respectively correspond to different target waveforms of the developing voltage may be stored in the memory 45 in advance. The controller 10 selects one of the aforementioned plurality of sets of first waveform information and second waveform information and transmits a command providing an instruction for the selected set to the signal generation circuit 46, to suppress a decrease in the developing performance caused by, for example, a change in an operating condition of the image-forming apparatus 100. In response to the received command, the signal generation circuit 46 selectively reads out, from the memory 45, the set of first waveform information and second waveform information selected by the controller 10, and generates the first control signal S_{C1} and the second control signal S_{C2} in accordance with the pieces of information that have been read out.

As an example, a first set among the plurality of sets includes first waveform information and second waveform information for generating an AC voltage component in which the ratio of the negative amplitude with respect to the positive amplitude is relatively small. A second set among the plurality of sets includes first waveform information and second waveform information for generating an AC voltage component in which the ratio of the negative amplitude with respect to the positive amplitude is relatively large. In this example, the duty ratio of the first control signal S_{C1} generated in accordance with the pieces of waveform information in the first set is larger than the duty ratio of the first control signal S_{C1} generated in accordance with the pieces of waveform information in the second set. Thus, three of more sets of first waveform information and second waveform information may be provided.

According to the above-described third embodiment, two switch pairs of the H-bridge circuit are turned ON and OFF at high speed through open control that uses a signal sequence that has been decided and stored in a memory in advance. In this way, the duty ratio between a period in which a positive voltage is applied to the primary-side circuit of the transformer and a period in which a negative voltage is applied thereto changes as designed, and consequently, an AC voltage component with desired positive and negative amplitudes can be generated in the secondary-side circuit of the transformer.

The voltage generation circuit 40 according to the third embodiment, also does not require voltage adjustment circuits of a conventional circuit configuration for causing positive and negative amplitudes of an AC component of a developing voltage to be different from each other. Therefore, the number of parts in an apparatus is reduced, the manufacturing cost is lowered, and at the same time, the degree of freedom of a circuit design can be enhanced to promote downsizing of a substrate.

In the third embodiment, as the signal waveforms of driving signals are defined by waveform information in advance, selectable options for the waveforms of a developing voltage that can be generated in the voltage generation circuit 40 are also limited to pre-defined candidates. However, in the above-described embodiment example, as a plurality of selectable options for waveform information are provided, the waveform of the developing voltage can be selected such that a decrease in the developing performance of the developing devices is suppressed depending on a change in an operating condition, such as a change in an environmental condition and deterioration of a member.

It should be noted that, in the above-described first and second embodiments, it is possible for the target control circuit 11 to generate a target waveform with an arbitrary amplitude and frequency (which is not limited to pre-defined options) to cause a waveform of the developing voltage to approach that target waveform. Therefore, in these embodiments, more flexible voltage control can be realized than in the third embodiment.

### 6. Other Embodiments

Embodiment(s) of the present disclosure can also be realized by a computer of a system or apparatus that reads out and executes computer executable instructions (e.g., one or more programs) recorded on a storage medium (which may also be referred to more fully as a non-transitory computer-readable storage medium) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to and the benefit of Japanese Patent Application No. 2024-171511, filed on Sep. 30, 2024 and Japanese Patent Application No. 2025-116028, filed on Jul. 9, 2025, each of which are hereby incorporated by references herein in their entirety.

What is claimed is:

1. An image-forming apparatus, comprising:
a developing device configured to develop an electrostatic latent image;
a voltage generation circuit configured to generate a developing voltage to be applied to the developing device;
a control circuit;
a detection circuit; and
a control signal generation circuit, wherein:
the voltage generation circuit includes:
a transformer,
an H-bridge circuit composed of a first switch and a second switch that are connected to a first terminal of a primary-side circuit of the transformer, and a third switch and a fourth switch that are connected to a second terminal of the primary-side circuit of the transformer,
a power source connected to the first switch and the third switch of the H-bridge circuit,
a driving circuit configured to output a first driving signal that controls ON and OFF of the first switch and the fourth switch, and a second driving signal that controls ON and OFF of the second switch and the third switch, and
a direct current (DC) output circuit configured to output a DC voltage,
the control circuit is configured to output a target voltage signal indicating a target waveform,
the detection circuit is configured to detect an alternating current (AC) voltage of the developing voltage output from the voltage generation circuit to the developing device, and output a detected voltage signal indicating a waveform of the detected AC voltage,
the control signal generation circuit is configured to generate a first control signal and a second control signal based on comparison between the target voltage signal from the control circuit and the detected voltage signal from the detection circuit, and output the generated first control signal and second control signal to the driving circuit, the first control signal providing an instruction for turning ON or OFF the first switch and the fourth switch, and the second control signal providing an instruction for turning ON or OFF the second switch and the third switch,
in a state where the first switch and the fourth switch are turned ON in accordance with the first driving signal output based on the first control signal, a positive voltage is applied to the primary-side circuit,
in a state where the second switch and the third switch are turned ON in accordance with the second driving signal output based on the second control signal, a negative voltage is applied to the primary-side circuit,
an AC voltage having an amplitude corresponding to a duty ratio between a period in which the positive voltage is applied and a period in which the negative voltage is applied is generated in a secondary-side circuit of the transformer, and
the voltage generation circuit is further configured to output, to the developing device, the developing voltage obtained by superimposing the AC voltage generated in the secondary-side circuit of the transformer on the DC voltage output from the DC output circuit.

2. The image-forming apparatus according to claim 1, wherein:
the control signal generation circuit is further configured to generate the first control signal for turning ON the first switch and the fourth switch in a case where the target voltage signal indicates a voltage greater than the detected voltage signal, and to generate the first control signal for turning OFF the first switch and the fourth switch in a case where the target voltage signal indicates a voltage less than the detected voltage signal, and
the control signal generation circuit is further configured to generate the second control signal for turning ON the second switch and the third switch in a case where the target voltage signal indicates a voltage less than the detected voltage signal, and to generate the second control signal for turning OFF the second switch and the third switch in a case where the target voltage signal indicates a voltage greater than the detected voltage signal.

3. The image-forming apparatus according to claim 1, wherein
the control signal generation circuit includes:
a feedback control circuit configured to output a modulated voltage signal that has been modulated to eliminate a deviation of the detected voltage signal relative to the target voltage signal through feedback control based on the deviation,
a carrier wave generation circuit configured to generate a carrier signal that has a frequency greater than a frequency of the AC voltage, and
a comparator configured to generate the first control signal and the second control signal based on comparison between the modulated voltage signal from the feedback control circuit and the carrier signal from the carrier wave generation circuit.

4. The image-forming apparatus according to claim 3, wherein
the feedback control circuit is configured to apply at least proportion control and integration control with respect to the deviation.

5. The image-forming apparatus according to claim 3, wherein
the control signal generation circuit is further configured to generate the first control signal for turning ON the first switch and the fourth switch in a case where the modulated voltage signal indicates a voltage greater than the carrier signal, and generates the first control signal for turning OFF the first switch and the fourth switch in a case where the modulated voltage signal indicates a voltage less than the carrier signal, and
the control signal generation circuit is configured to generate the second control signal for turning ON the second switch and the third switch in a case where the modulated voltage signal indicates a voltage less than the carrier signal, and generates the second control signal for turning OFF the second switch and the third switch in a case where the modulated voltage signal indicates a voltage greater than the carrier signal.

6. The image-forming apparatus according to claim 3, wherein
the carrier signal is a triangle wave.

7. The image-forming apparatus according to claim 1, wherein
the control circuit is further configured to control the target waveform to suppress a decrease in a developing performance of the developing device caused by a change in an operating condition of the image-forming apparatus.

8. The image-forming apparatus according to claim 1, wherein
the first switch and the third switch of the H-bridge circuit are connected directly to the power source without intervention of a voltage adjustment circuit.

9. The image-forming apparatus according to claim 1, wherein
the second switch and the fourth switch of the H-bridge circuit are grounded.

10. The image-forming apparatus according to claim 1, further comprising an image bearing member configured to bear the electrostatic latent image,
wherein the image developed by the developing device is borne by the image bearing member.

11. An image-forming apparatus, comprising:
a developing device configured to develop an electrostatic latent image;
a control signal generation circuit; and
a voltage generation circuit configured to generate a developing voltage to be applied to the developing device, wherein:
the voltage generation circuit includes
a transformer,
an H-bridge circuit composed of a first switch and a second switch that are connected to a first terminal of a primary-side circuit of the transformer, and a third switch and a fourth switch that are connected to a second terminal of the primary-side circuit of the transformer,
a power source connected to the first switch and the third switch of the H-bridge circuit,
a driving circuit configured to output a first driving signal that controls ON and OFF of the first switch and the fourth switch, and a second driving signal that controls ON and OFF of the second switch and the third switch, and
a direct current (DC) output circuit configured to output a DC voltage,
the control signal generation circuit is configured to read out, from a memory, first waveform information defining a signal waveform of the first driving signal and second waveform information defining a signal waveform of the second driving signal, and output a first control signal generated in accordance with the first waveform information and a second control signal generated in accordance with the second waveform information to the driving circuit,
the driving circuit is configured to generate the first driving signal by amplifying the first control signal, and generate the second driving signal by amplifying the second control signal,
in a state where the first switch and the fourth switch are turned ON in accordance with the first driving signal, a positive voltage is applied to the primary-side circuit,
in a state where the second switch and the third switch are turned ON in accordance with the second driving signal, a negative voltage is applied to the primary-side circuit,
an alternating current (AC) voltage having an amplitude corresponding to a duty ratio between a period in which the positive voltage is applied and a period in which the negative voltage is applied is generated in a secondary-side circuit of the transformer,
the voltage generation circuit is further configured to output, to the developing device, the developing voltage obtained by superimposing the AC voltage generated in the secondary-side circuit of the transformer on the DC voltage output from the DC output circuit, and
the signal waveform defined by the first waveform information and the signal waveform defined by the second waveform information indicate a series of pulses for pulse width modulation at a frequency greater than a frequency of the AC voltage throughout an entire cycle of the AC voltage.

12. The image-forming apparatus according to claim 11, wherein:
a plurality of sets of the first waveform information and the second waveform information that respectively correspond to different target waveforms of the developing voltage have been stored in the memory in advance, and
the control signal generation circuit is further configured to selectively read out one of the plurality of sets of the first waveform information and the second waveform information, and generate the first control signal and the second control signal in accordance with the first waveform information and the second waveform information in the set that has been selectively read out, to suppress a decrease in a developing performance of the developing device caused by a change in an operating condition of the image-forming apparatus.

13. The image-forming apparatus according to claim 11, wherein
the first switch and the third switch of the H-bridge circuit are connected directly to the power source without intervention of a voltage adjustment circuit.

14. The image-forming apparatus according to claim 11, wherein
the second switch and the fourth switch of the H-bridge circuit are grounded.

15. The image-forming apparatus according to claim 11, further comprising an image bearing member configured to bear the electrostatic latent image,
wherein the image developed by the developing device is borne by the image bearing member.
